(19) United States
(12) Patent Application Publication
(10) Pub. No.: US 2024/0417210 A1
(43) Pub. Date: Dec. 19, 2024

(54) Induction Bonded Reel Having a Hub Member

(71) Applicant: Vandor Corporation, Richmond, IN (US)

(72) Inventor: Richard Brown, Richmond, IN (US)

(21) Appl. No.: 18/739,441

(22) Filed: Jun. 11, 2024

Related U.S. Application Data
(60) Provisional application No. 63/508,783, filed on Jun. 16, 2023.

(51) Int. Cl. B65H 75/14; B29C 65/38; B29L 31/00; H05B 6/10

(52) U.S. Cl. CPC B65H 75/14; H05B 6/105; B29C 65/38; B29L 2031/704

(57) ABSTRACT

A reel includes a core having a first end region, a first flange, a first hub member, and a first bonded joint connecting the first hub member to the first end region of the core. The first bonded joint includes a first susceptor material arranged between the first hub member and the first end region of the core. The first hub member and the first end region of the core are bonded together around the first susceptor material in such a way that the first flange is interposed between the first hub member and the first end region of the core.

### CROSS-REFERENCE TO RELATED APPLICATION

This application claims priority to U.S. Provisional Application Ser. No. 63/508,783, which is titled “Induction Bonded Reel with Hub Member” and was filed on Jun. 16, 2023, the disclosure of which is incorporated herein by reference in its entirety.

### FIELD

This disclosure relates generally to apparatus for supporting wound flexible media, for example, cord, cable, fiber or wire.

### BACKGROUND

The transport and use of cable, wire, optical fiber, and other wound media typically involves winding the flexible media on a spool or reel. Typical reels for construction purposes can have a traverse length (or axial height) of any length, and any flange diameter. Reels generally consist of a core around which the wound media is wrapped, and two flanges at opposite ends of the core. Such reels can be made of wood (e.g. plywood) or chipboard, but are often constructed of plastic and/or corrugated paper to obtain better strength-to-weight ratios, ease of machining or molding, and to provide suitable stiffness of the flanges.

The conventional method of assembly of a reel utilizes metal T-nut threaded inserts that are mounted into one end of the flange. Metal bolts pass through from the opposite end of the flange and thread into the inserts to mate the flanges to the core. However, T-nuts and bolts tend to contribute a high percentage to the overall cost of the reel. Additionally, the traverse length of the reel is limited to standard available bolt lengths so that the bolts do not protrude past the outside faces of the flanges.

There is a need, therefore, for a reel design that simplifies manufacturing and reduces cost, while maintaining sufficient structural integrity for normal use.

### SUMMARY

The disclosure provides a reel design that is comprised of a core and hub member that may be formed at least partially of similar plastic materials, and flanges made from a material that may be formed of a similar or a dissimilar material to provide desired characteristic benefits that are not tied to the material of the core. The reel according to the disclosure also enables the traverse distance (i.e. the core axial length) to be of any desired length, which allows the reel to be sized for any suitable length of wound flexible media.

In one embodiment according to the disclosure, a reel includes a core having a first end region, a first flange, a first hub member, and a first bonded joint connecting the first hub member to the first end region of the core. The first bonded joint includes a first susceptor material arranged between the first hub member and the first end region of the core. The first hub member and the first end region of the core are bonded together around the first susceptor material in such a way that the first flange is interposed between the first hub member and the first end region of the core.

In another embodiment according to the disclosure, a method of producing a reel includes arranging a first hub member in a plurality of apertures in a first flange, arranging each one of a plurality of susceptor members into a corresponding one of the plurality of apertures, inserting a first end region of a core into an annular channel of the first flange, and applying a magnetic field to the plurality of susceptor members to produce a bonded joint between at least the first end region of the core and the hub member.

### BRIEF DESCRIPTION OF THE DRAWINGS

FIG. 1 is a side perspective view of a reel according to the disclosure.

FIG. 2 is an exploded side perspective view of the reel of FIG. 1.

FIG. 3 is a top perspective view of the inner side of a flange of the reel of FIG. 1.

FIG. 4 is a detail plan view of the core nest region of the flange of FIG. 3.

FIG. 5 is an exploded side perspective view of a hub member and susceptor members of the reel of FIG. 1.

FIG. 6 is a side perspective view of the susceptor members arranged in the hub member of FIG. 5.

FIG. 7 is a top perspective view of a hub member of the reel of FIG. 5 with the susceptor members arranged in the hub member.

FIG. 8 is a top view of a projection of the hub member of FIG. 5 with a susceptor arranged in the projection.

FIG. 9 is a side perspective cutaway view of the bonded joint formed by the susceptor material, the core, the flange, and the hub member in the reel of FIG. 1.

FIG. 10 is a detail side cross-sectional view of the bonded joint of FIG. 9.

FIG. 11 is a side cross-sectional view of the reel of FIG. 1.

FIG. 12 is a process diagram of a method of producing a reel such as the reel of FIG. 1.

FIG. 13 is an exploded side perspective view of another embodiment of a reel according to the disclosure.

FIG. 14 is a side cross-sectional view of the reel of FIG. 13.

FIG. 15 is a detail side cross-sectional view of the reel of FIG. 13 in an assembled but not bonded state.

FIG. 16 is a detail side cross-sectional view of the bonded joint of the reel of FIG. 13.

### DETAILED DESCRIPTION

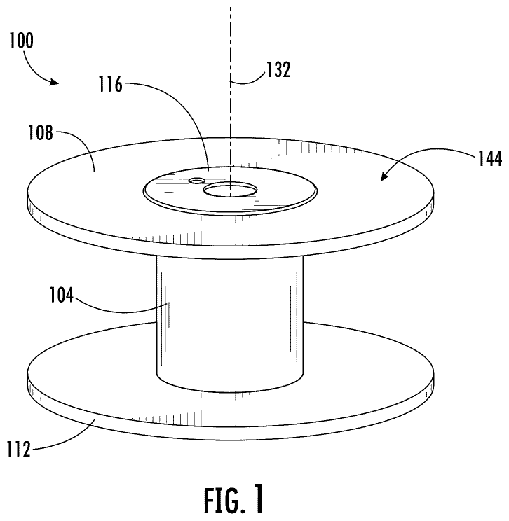

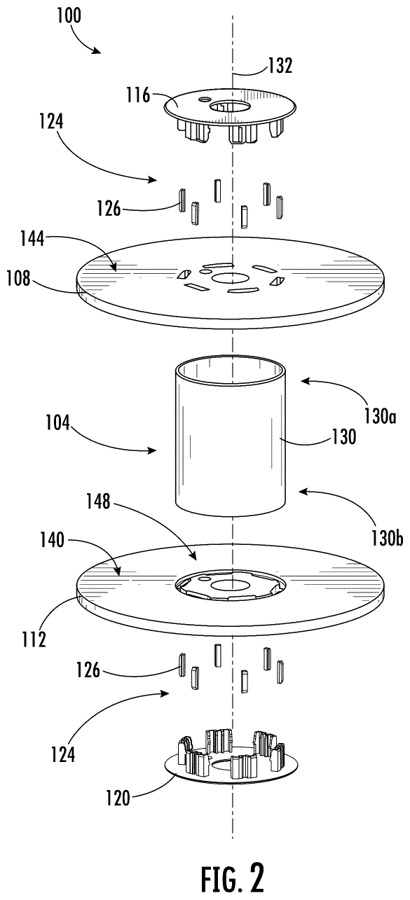

FIG. 1 shows a perspective view of an exemplary embodiment of a reel 100 according to the disclosure, and FIG. 2 shows an exploded perspective view of the reel 100 of FIG. 1. With reference to FIGS. 1 and 2, the reel 100 includes a core 104, a first flange 108, a second flange 112, a first hub member 116, and a second hub member 120. The first and second hub members 116, 120 are connected to the core 104 via a bonded joint 122, which may also be referred to as a welded joint, in such a way that the respective first or second flange 108, 112 is fixed in position between the hub member 116, 120 and the core 104. The reel 100 is configured such that flexible media, which can include cable, wire, fiber optical cable, rope, string, etc., can be wound around the core 104 and axially retained on the core 104 by the flanges 108, 112.

The flanges 108, 112, hub members 116, 120, and bonded joint 122 are substantially identical at each end of the core 104. The following description therefore only describes the connection between one end of the core 104, one of the flanges 108, and one of the hub members 116, though the reader should appreciate that the connection between the flange 112 and hub member 120 at the opposite end of the core 104 may be substantially identical. In some embodiments, however, only one flange is connected to the core via the hub and the bonded joint, while the other flange may be connected to the core by another desired connection arrangement.

The core 104 is formed as a hollow cylindrical body 130 that has a first end region 130a and a second end region 130b, and that defines a central axis 132 of the reel 100. In some embodiments, the core 104 is formed of plastic. In one embodiment, the core 104 may be formed of polypropylene plastic, while in other embodiments, the core 104 is formed of polyethylene, polycarbonate, ABS, polystyrene, nylon, a combination of one or more of the aforementioned materials, or another desired material. The core 104 may be formed of a single piece of material, or it may be formed of a plurality of pieces attached together to form the cylindrical body 130.

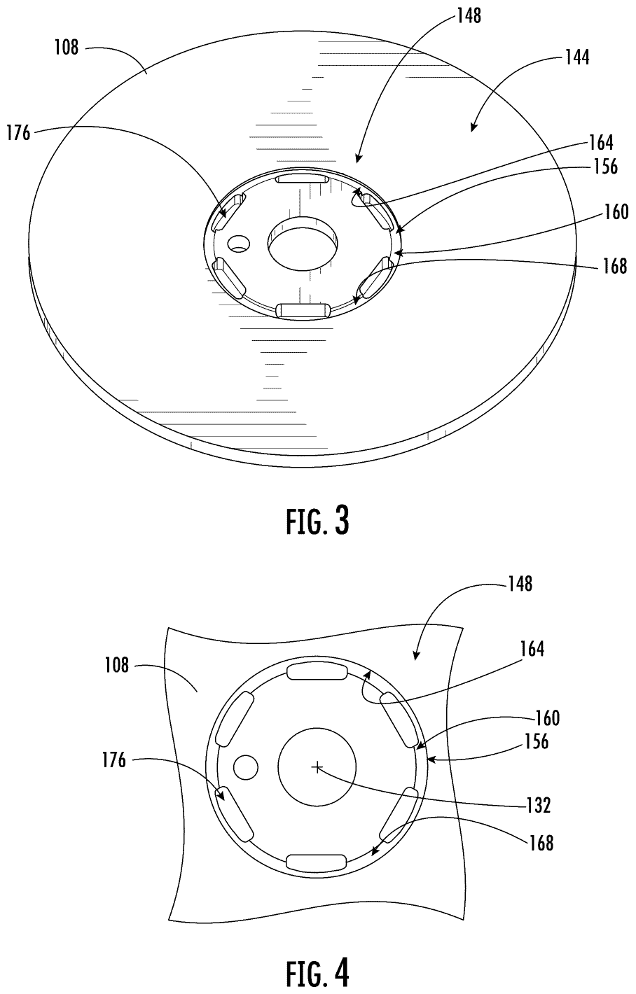

FIGS. 3 and 4 illustrate the flange 108 in further detail, with the understanding that the flange 112 is substantially or entirely identical to the flange 108 depicted in FIGS. 3 and 4. The flange 108 is generally disk-shaped, with an inner side 140 (i.e. the side facing toward the opposite flange 112) and an outer side 144. The flange 108 has a core nest region 148 located in the centrally in the flange 108 and in which the flange 108 is connected to the core 104 via the hub member 116 and the bonded joint 122.

The flanges 108, 112 may be formed of a material that is similar or dissimilar to the material of the core 104. In particular, the flanges 108, 112 may be formed of a similar material such as plastic, for example, polypropylene plastic, polyethylene, polycarbonate, ABS, polystyrene, nylon, a combination of one or more of the aforementioned materials, or another desired material. In some other embodiments, however, the flanges 108, 112 may be formed of a material that is dissimilar from the material of the core 104 such as, for example, plywood, chipboard, other plastics, wood, corrugated material, paperboard, etc. In particular, the flanges 108, 112 may be formed of a material that is dissimilar from the plastic of the core 104, but is less expensive, stronger, easier to machine, and/or has greater stiffness.

The inner side 140 of the core nest region 148 defines a generally annular channel 156 (also referred to as a core nest) centered at the central axis 132. The annular channel 156 has substantially the same diameter as the core 104, and is formed by a generally circular inner wall 160, a generally circular outer wall 164, and a base surface 168. The annular channel 156 therefore forms a tight engagement axially and/or circumferentially (either around the inner diameter, the outer diameter, or a combination of both) with the core 104 so as to form the nest for the core 104.

In addition, the core nest region 148 defines a plurality of elongated apertures 176 spaced around the central axis 132. In the illustrated embodiment, there are six elongated apertures 176 evenly spaced around the central axis 132, though the reader should appreciate that other embodiments include a different number of apertures and/or irregularly spaced apertures. As seen in FIGS. 3 and 4, the elongated apertures 176 are arranged so as to be partially radially inside the inner wall 160 of the annular channel 156, and partially radially between the inner and outer walls 160, 164 of the annular channel 156, such that part of each elongated aperture 176 is defined through the base surface 168 of the annular channel 156.

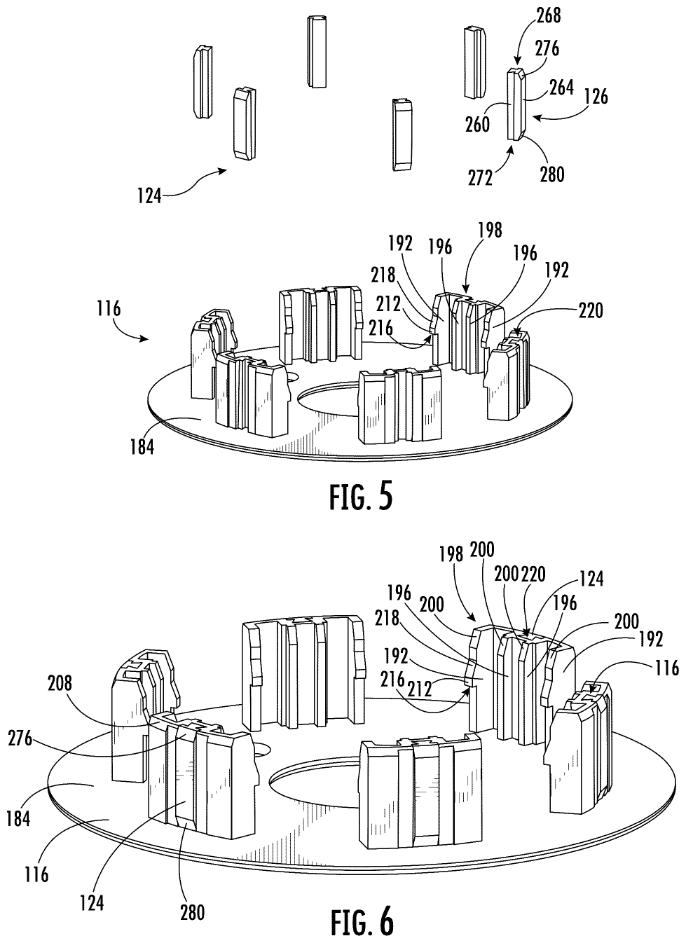

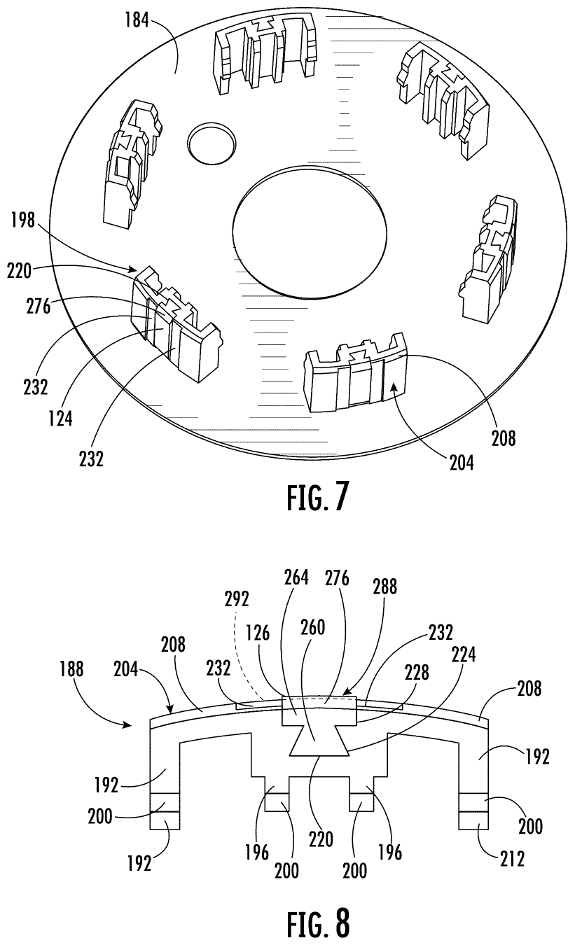

Next, the hub member 116 and the bonded joint 122 formed by susceptor material 124 will be described with reference to FIGS. 5-7, with FIG. 5 showing an exploded view of the hub member 116 and the susceptor members 126 of the susceptor material 124, and FIGS. 6 and 7 depicting the hub member 116 and susceptor material 124 connected to one another. Again, the reader should appreciate that the hub member 120 at the opposite end of the core 104 may be substantially or entirely identical to the hub member 116 described below.

The hub member 116 includes an outer disk 184 and a plurality of projections 188 that extend axially from the inner side of the outer disk 184, i.e. the side of the outer disk 184 that faces toward the flange 108 and core 104. In particular, the projections 188 are shaped and sized so as to fit through the elongated apertures 176 of the flange 108. Each of the projections 188 has two outer radial ribs 192 and two inner radial ribs 196. As will be discussed in detail below, the outer radial ribs 192 enable a snap-fit connection of the hub member 116 to the flange 108, while the inner radial ribs 196 provide additional structural support to the projections 188.

At the distal end 198 of each projection 188, the inner and outer radial ribs 196, 192 each include a lead-in portion 200 that is chamfered. Likewise, the radially outer side 204 of the projections 188 also includes a lead-in portion 208. The lead-in portions 200, 208 facilitate inserting the projections 188 through the elongated apertures 176.

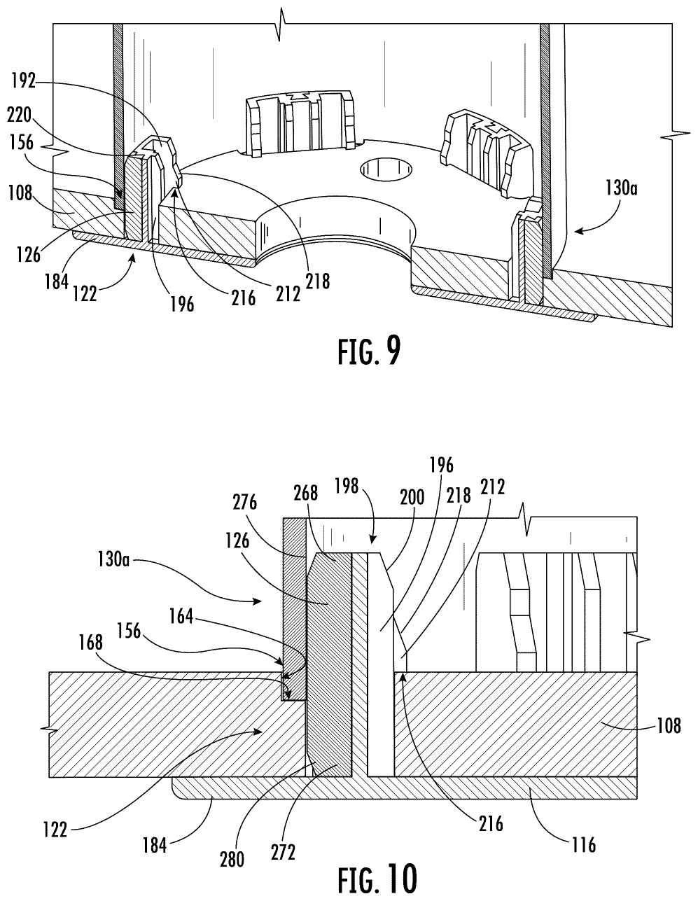

In addition, the outer radial ribs 192 each include a protuberance 212 that extends further radially inwardly from a portion of the projection 188 between the lead-in portion 200 and the outer disk 184. In particular, as seen best in FIGS. 9 and 10, an end surface 216 of the protuberance 212 facing toward the outer disk 184 is spaced apart from the outer disk 184 by approximately the width of the flange 108 to enable the protuberance 212 to fix the flange 108 between the end surface 216 of the protuberance 212 and the outer disk 184. Additionally, the distal end of the protuberance 212 forms another chamfered lead-in 218 that facilitates insertion of the protuberance 212 through the associated elongated aperture 176.

Referring back to FIGS. 5-8, to accommodate the susceptor members 126, a groove 220 is defined in the projection 188 on the radially outer side 204 thereof, extending axially from the outer disk 184 to the distal end 198 of the projection 188. As best seen in FIG. 8, the radially inner portion 224 of the groove 220 has a trapezoidal or wedge shape, and the radially outer portion 228 has a generally rectangular shape. On both circumferential sides of the groove 220, the projection 188 defines a flow channel 232 that extends axially from the outer disk 184 to the distal end of the projection 188.

The hub members 116, 120, or at least the projections 188 thereof, are formed of a plastic material that is similar to the material from which the core 104 is formed. Specifically, in one embodiment, the projections 188 may be formed of polypropylene plastic, while in other embodiments, the projections 188 are formed of polyethylene, polycarbonate, ABS, polystyrene, nylon, a combination of one or more of the aforementioned materials, or another desired material. The hub member 116, 120 may be formed of a single piece of material, or the outer disk 184 may be formed of a different material than the projections 188.

Each of the susceptor members 126 is shaped generally complementarily to the groove 220 of the projection 188, and includes an inner portion 260 that is generally trapezoidal or wedge shaped and an outer portion 264 that is generally rectangularly shaped. Thus, the susceptor member 126 is fitted in the groove 220 by a wedge fit. In other embodiments, however, the groove 220 and the susceptor member 126 may have different shapes, and/or the susceptor member 126 may be connected to the groove 220 via, for example, a press fit or an interference fit. Additionally, in one embodiment, both the distal end 268 and the proximal end 272 of the susceptor member 126 includes a lead-in portion 276, 280, respectively, to facilitate insertion of the susceptor member 126 into the groove 220 and through the elongated aperture 176.

FIG. 8 illustrates that the susceptor member 126 is configured such that, when installed into the groove 220, the outer radial end 288 of the susceptor member 126 extends slightly beyond the outer radius 292 of the radially outer side 204 of the projection 188. As will be discussed in further detail below, this configuration results in radial compression acting on the susceptor member 126, which facilitates the bonding of the susceptor member 126 to the core 104 and the projection 188.

The susceptor material 124 is formed of a plastic material impregnated with a susceptor, which is, for example, ferrous material. More specifically, the plastic of the susceptor material 124 is compatible with the plastics of both the core 104, specifically the end regions thereof if the core 104 is formed of more than one material, and the hub members 116, 120, specifically the projections 188 if the hub members 116, 120 are formed of more than one material. In one embodiment, the susceptor material 124 is a polypropylene plastic impregnated with metal powder or metal flakes, more specifically iron powder or iron flakes. In other embodiments, the susceptor material 124 may be polyethylene, polycarbonate, ABS, polystyrene, nylon, or another desired material impregnated with metal powder or flakes.

The susceptor members 126 may be formed by extrusion or by injection molding. In some embodiments, the susceptor members 126 are formed as part of a two-shot injection molding process during which the hub member 116 is formed in the first shot and the susceptor members 126 are formed within the respective groove 220 in the second shot. In another embodiment, the susceptor members 126 are formed in a separate injection molding process from the hub member 116, the susceptor members 126 are extruded directly onto the hub member 116, or the susceptor material 124 is extruded as a continuous bead or rope and cut to the desired length to form the susceptor members 126.

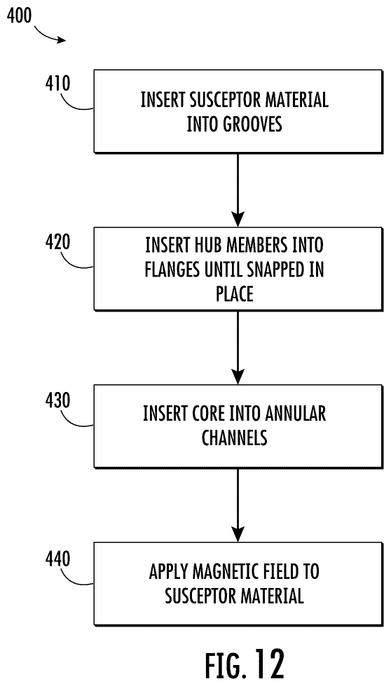

Assembly of the reel 100 will now be described with particular reference to FIGS. 9-11, and in association with the method 400 illustrated in the process diagram of FIG. 12. The reel 100 according to the disclosure may be assembled with one flange 108, 112 connected to the core 104 at a time, or the reel 100 may be assembled with both flanges 108, 112 connected to the core 104 at the same time. The following description of the method 400 describes the installation of both flanges 108, 112 simultaneously, though the reader should appreciate that the flanges 108, 112 may be connected to the core 104 sequentially as well. Additionally, the reader should appreciate that the following assembly steps may be performed in a different order than described below, and that certain of the assembly steps may be performed sequentially on one flange and then on the other flange rather than simultaneously.

If the susceptor members 126 are not already installed into the grooves 220 of the projections 188, the method begins with inserting the susceptor members 126 into the grooves 220 (block 410). This step may be omitted, however, if the susceptor material 124 is formed concurrently with the hub members 108, 112 or if the susceptor material 124 is injected or extruded directly into the grooves 220.

Then, the hub members 116, 120 are positioned such that the projections 188 pass through the elongated apertures 176 of the associated flange 108, 112 (block 420). The lead-ins 200, 208, 276 facilitate alignment and insertion of the projections 188 into the elongated apertures 176. In addition, as the protuberance 212 contacts the flange 108, 112, the lead-in 218 combined with elastic flexibility of the plastic projection 188 enables the projection 188 to bend radially outwardly to allow the protuberance 212 to pass through the elongated aperture 176.

Once the protuberance 212 passes entirely though the elongated aperture 176, the projection 188 snaps back inwardly such that the end surface 216 of the protuberance 212 overlaps the inner surface of the flange 108, 112, thereby forming a snap-fit connection between the protuberances 212 and the flange 108, 112. As a result, the hub members 116, 120 are connected to their respective flanges 108, 112.

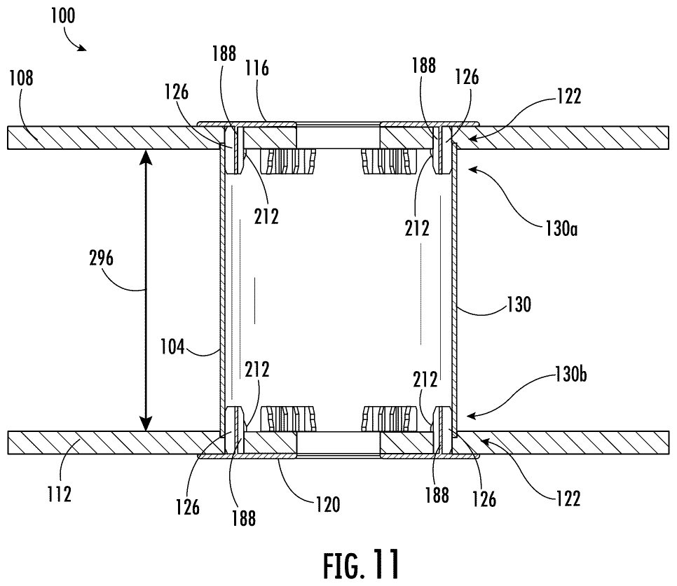

Each flange 108, 112 is then aligned with a respective end of the core 104 such that the end of the core 104 is arranged within the annular channel 156 of the associated flange 108, 112 (block 430). The lead-ins 208 on the radially outer side 204 of the projections 188 and the lead-ins 276 at the distal end 272 of the susceptor members 126 allow the core 104 to fit tightly over the projections 188. Furthermore, since the nominal outer radius of the outer radial end 288 of the susceptor members 126 is greater than the radius 292 of the projection 188, the core 104 exerts a radially-inwardly directed force on the susceptor members 126 such that the susceptor material 124 is compressed between the core 104 and the hub member 116, 120, and the core 104 is compressed between the outer wall 164 of the channel 156 and the susceptor members 126. The core 104 can then be reliably positioned such that the two flanges 108, 112 are at a precise distance from one another, thereby allowing for precise setting of the traverse length 296 (FIG. 11) of the reel 100.

The susceptor members 126 are then subjected to a magnetic field (block 440). In particular, both flanges 108, 112 and both ends of the core 104 The metal impregnated in the material of the susceptor members 126 is excited by the application of the magnetic field, which causes the ferrous material to generate heat. The heat increases the temperature of the plastic in the susceptor material 124, which causes the plastic to at least partially melt. Because the outer surface 288 of the susceptor members 126 extends radially beyond the outer radius 292 of the projection 188, the radial pressure compressing the susceptor material 124 between the core 104 and the projections 188 facilitates transfer of the heat of the susceptor material 124 to the core 104 and the projection 188, thereby melting the plastic material of the core 104 and the projection 188 at their respective interfaces with the susceptor material 124. Moreover, because of the radial pressure exerted on the susceptor material 124, the induction bonding can be accomplished with relatively little axial pressure, or in some embodiments no axial pressure, exerted on the flanges 108, 112. As a result, the traverse length 296 remains fixed at the desired distance during the bonding process.

The melted susceptor material 124 squeezes into the flow channel 232, at least partially filling the flow channels 232. As a result, the surface area of interface between the susceptor material 124 and the core 104 and the projections 188 is relatively large, providing an improved bond therebetween. Furthermore, the flow channel 232, in combination with the tight fit between the core 104 and the annular channel 156, helps to prevent the melted susceptor material 124 from passing into the annular channel 156 and seeping out of the annular channel 156 where the subsequently solidified susceptor material could interfere with the media stored on the reel 100. In particular, some embodiments of the reel 100 are configured such that the tolerances between the core 104 and the walls 160, 164 of the annular channel 156 are 1/16 inch or less, and in particular 1/32 inch or less, and more particularly 0.0015 inches or less to prevent the susceptor material 124 from leaking to the outer side of the core 104 and into the region of the reel 100 where the wound material is present.

During the application of the magnetic field, the melted susceptor material 124 mixes with the melted plastic material of the core 104 and the projection 188 such that, when the magnetic field ceases, the susceptor material 124, core 104, and projection 188 fuse together, i.e. are welded together, at their interfaces to form a tightly bonded joint 122 between the core 104, susceptor material 124, and the associated hub member 116, 120.

The flanges 108, 112 may also be partially bonded to the susceptor material 124 at the interface between the susceptor material 124 and the flange 108, 112. However, since the flanges 108, 112 are fixed between the end surface 216 of the protuberances 212 and the outer disk 184 of the associated hub member 116, 120, the flanges 108, 112 are securely connected to the hub members 116, 120 even if the flanges 108, 112 are not bonded to the hub members 116, 120. As a result, the flanges 108, 112 need not be formed of a similar material as the core 104 and hub members 116, 120 to form a secure connection therebetween. Accordingly, the flanges 108, 112 may be formed from a material that is different from the material of the core 104, and therefore the material of the flanges 108, 112 may be selected based on different considerations and desired properties as compared to the core 104.

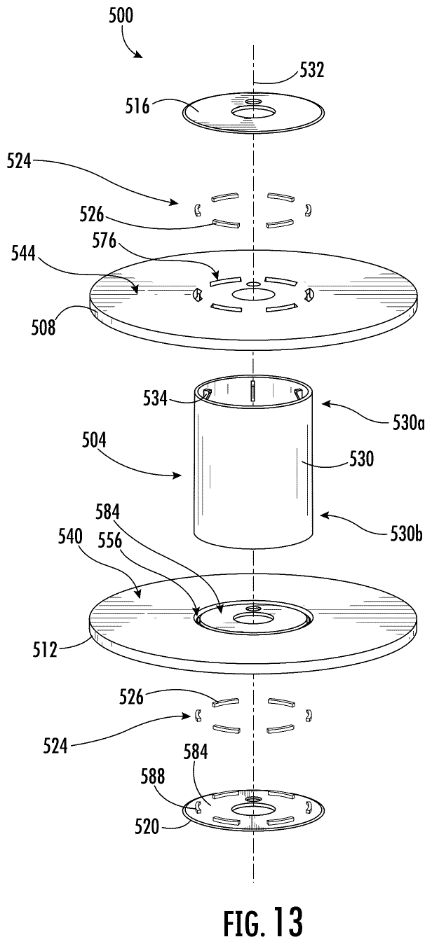

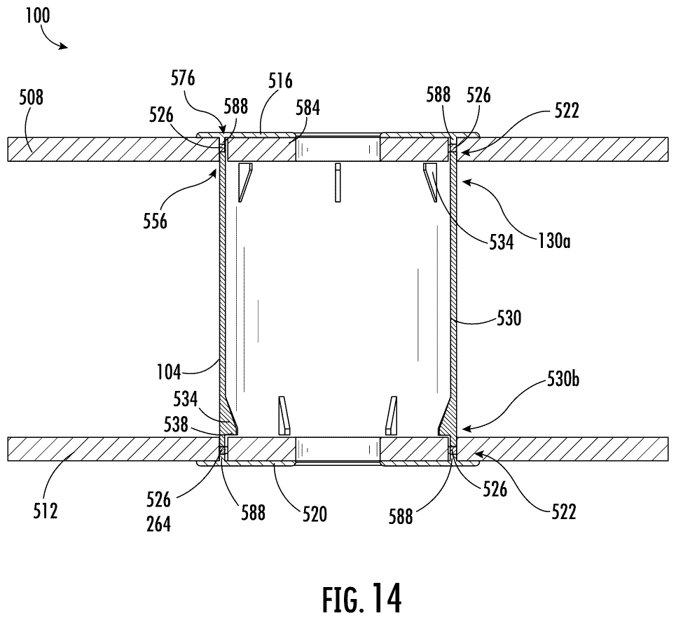

FIGS. 13-16 illustrate a second embodiment of a reel 500 according to the disclosure. In the assembled or connected state, the reel 500 is configured similarly to the reel 100 described above. However, the bonded joint 522, also referred to herein as a welded joint, of the reel 500 differs from the bonded joint 122 described above.

The reel 500 includes a core 504, a first flange 508, a second flange 512, a first hub member 516, and a second hub member 520. The first and second hub members 516, 520 are connected to the core 504 via the bonded joint 522 in such a way that the respective first or second flange 508, 512 is fixed in position between the hub member 516, 520 and the core 504. The reel 500 is configured such that flexible media, which can include cable, wire, fiber optical cable, rope, string, etc., can be wound around the core 504 and axially retained on the core 504 by the flanges 508, 512.

The core 504 is formed as a hollow cylindrical body 530 that has a first end region 530a and a second end region 530b, and that defines a central axis 532 of the reel 500. The core 504 may be configured substantially the same as the core 104 described above. However, the core 504 includes a plurality of ribs 534 projecting inwardly from an inner circumferential wall 536 of the body 530 at each end region 530a, 530b thereof. Each of the ribs 534 forms a ledge 538 configured such that the ledges 538 at each end region 530a, 530b form a respective plane. In the illustrated embodiment, the core 504 includes six ribs 534, though the reader should appreciate that the number of ribs 534 varies in other embodiments.

In the illustrated embodiment, the flanges 508, 512, hub members 516, 520, and bonded joints 522 are substantially identical at each end of the core 504. The following description therefore only describes, one end of the core 504, one of the flanges 508, one of the hub members 516, and one bonded joint 522, though the reader should appreciate that the flange 512, hub member 520, and the bonded joint 522 at the opposite end of the core 504 is substantially identical. In some embodiments, however, only one flange is connected to the core via the hub and the bonded joint, while the other flange may be connected to the core by another desired connection arrangement.

The flange 508 is generally disk-shaped, with an inner side 540 (i.e. the side facing toward the opposite flange) and an outer side 544. The flange 508 has a core nest region 548 located centrally in the flange 508 and in which the flange 508 is connected to the core 504 via the hub member 516 and the susceptor material 524. The flanges 108, 112 may be formed of the same materials discussed above with regard to the flanges 108, 112.

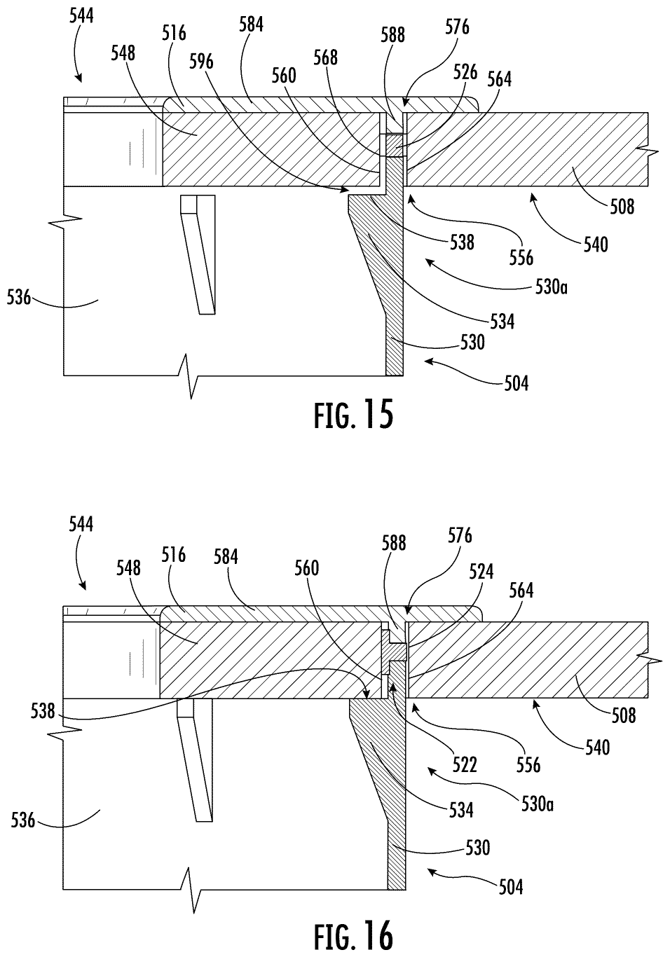

The inner side 540 of the core nest region 548 defines a generally annular channel 556 (also referred to as a core nest) centered at the central axis 532. As is best seen in FIGS. 15 and 16, the annular channel 556 has substantially the same diameter as the core 504, and is formed by a circumferential inner wall 560, a circumferential outer wall 564, and a base surface 568.

In addition, the outer side 544 of the core nest region 548 defines a plurality of elongated apertures 576 spaced around the central axis 532. In the illustrated embodiment, there are six elongated apertures 576 evenly spaced around the central axis 532, though the reader 5should appreciate that other embodiments include a different number of apertures and/or irregularly spaced apertures. In particular, in some embodiments, the number of elongated apertures 576 may be the same as the number of ribs 534 on the inner wall 536 of the core body 530. The elongated apertures 576 are formed as axial continuations of the inner and outer walls 560, 564. In one embodiment, each elongated aperture may have an angular extent in the circumferential direction of between approximately 20 degrees and approximately 45 degrees. Next, the hub member 516 and the bonded joint 522 will be described with particular

reference to FIGS. 15 and 16, with FIG. 15 showing a detail view of the region of the bonded joint 522 prior to application of a magnetic field to the susceptor material 524, and FIG. 16 depicting the completed bonded joint 522 after application of the magnetic field to the susceptor material 524.

The hub member 516 includes a disk portion 584 and a plurality of projections 588 that extend axially from the inner side of the outer disk 584, i.e. the side of the outer disk 584 that faces toward the flange 508 and core 504. In particular, the projections 588 are formed as arc portions sized so as to fit through the elongated apertures 576 of the flange 508 and, more specifically, the projections 588 may be complementary to and slightly smaller than the elongated apertures 576, and with a width in the axial direction of between approximately ⅓ and ⅔ of the depth of the elongated apertures 576 in the axial direction.

The hub members 516, 520, or at least the projections 588 thereof, are formed of a plastic material that is similar to the material from which the core 504 is formed. Specifically, the hub members 516, 520 may be formed of the same materials discussed above with regard to the hub members 116, 120.

The susceptor material 524 is formed as a plurality of elongated arcuate susceptor members 526, each of which is shaped generally complementarily to a corresponding one of the elongated apertures 576, and each the susceptor member 526 is arranged in the corresponding elongated aperture 576. In one embodiment,

In some embodiments, the susceptor material 524 does not include a plastic binder, and instead includes only the ferrous material. For example, the susceptor members 526 may be formed as ferrous mesh or wires that contact at least the hub member 516 and the end region 530a of the core 504. The overall axial length of the projections 588, the susceptor members 526, and the portion of the core 504 beyond the ledges 538 is slightly greater than the width of the flange 508 at the core nest region 544. In particular, the overall axial length of the projections 588, the susceptor members 526, and the portion of the core 504 beyond the ledges 538 may be at least 0.06 inches greater than the width of the flange 508 at the core nest region 544. As a result, when assembling the core 504, flange 508, hub member 512, and susceptor material 524, there is a gap 596 between the flange 508 and the ledge 538 and/or the inner surface of the hub member 512.

The reel 500 is produced in a similar process as the process 400 described above. Specifically, the flange 508 is aligned to the hub member 516 with the hub projections 588 extending into the elongated apertures 576 of the flange 508. Each of the susceptor members 526 is placed into a corresponding one of the elongated apertures 576 such that the susceptor members 526 rest on the projections 588 of the hub member 516. As noted above, the susceptor members 526 protrudes beyond the elongated apertures 576 and into the annular channel 556 by, for example, at least 0.06 inches.

The end region 530a of the core 504 is then inserted into the annular channel 556 such that the end surface of the core 504 rests on the susceptor members 526. Axial pressure is applied to urge the core 504 and the hub member 516 together. A magnetic field is applied during application of the axial pressure, thereby heating and melting the susceptor material 524. During the induction weld process, the heated susceptor material 524 is forced into the gaps between the flange 504, the hub member 516, and the core 504, while also heating the contact areas of the hub member 516 and the core 504, thereby producing a permanent bonded joint 522 between the hub member 516 and the core 504.

Additionally, in the embodiment of FIGS. 13-16, the susceptor material 524 also bonds to the material of the flange 508, in particular to the inner wall 560 of the annular channel 556 and the elongated apertures 576. Accordingly, the end region 530a of the core 504 is bonded to the projection 588 of the hub member 516 and the flange 508, either directly or indirectly via the susceptor material 524.

In some other embodiments, however, the susceptor material 524 does not bond to the flange 508. Because the axial compression applied during the induction weld results in the flange 508 being clamped between the disk portion 584 of the hub member 516 and the ledges 538 of the ribs 534 formed in the interior of the core body 530, the flange 508 is captively fixed between the core 504 nad the hub member 516 even if it is not bonded to either the core 504 or the hub member 516.

The end region 530a of the core 504 and the projections 588 are configured to be closer to the radially outer side of the annular channel 556 and elongated apertures 576, respectively, such that there is a greater clearance on the inner radial side of the core 504 and the projections 588. As a result, any excess susceptor material 524 flows radially inwardly toward the interior of the annular channel 556. Thus, the likelihood of the susceptor material 524 flowing into the region at the outer surface of the core 504, where the media is wound around the core, is reduced or eliminated. Thus, the susceptor material 524 is prevented from causing damage to the wound media.

After assembly of one end of the reel 500, the same process may be completed for the opposite end of the core 504 to form the completed reel 500. The reader should appreciate, however, that assembly of the reel 500 is not limited to bonding one flange at a time; in some embodiments, both flanges 508, 512 and hub members 516, 520 are bonded to the opposite end regions 530a, 530b of the core 504 simultaneously.

In another embodiment, the susceptor material can be extruded directly onto the hub member 516 prior to the reel assembly. Alternatively, in still another embodiment, the susceptor members 526 are injection molded directly onto the protrusions 588 of the hub member 516 prior to reel assembly, for example in a two-shot injection molding process during formation of the hub member 516.

As noted above, in some embodiments, the susceptor material is formed as a susceptor without any plastic binder material. In such an embodiment, the application of the magnetic field to the susceptor material 524 heats the susceptor material 524 and causes the material at the end surface of the core 504 and the projection 588 of the hub 516 that is adjacent to the susceptor material 524 to melt together. Thus, in this embodiment, the end region 530a of the core 504 and the projection 588 are fused directly to one another around the susceptor material 524.

In the embodiments described above, the reels 100, 500 are depicted having two flanges 108, 112, 508, 512. The reader should appreciate, however, that the reels 100, 500 may have more than two flanges, including one or more intermediate flanges arranged between two end flanges. The intermediate flanges may be bonded or welded to intermediate locations of the core in a similar manner as described above, or, in some embodiments, a separate core is arranged between each adjacent pair of flanges, and the separate cores may be bonded to each of the adjacent flanges with a respective hub member in a similar manner as described above.

It will be appreciated that the above-described embodiments are merely illustrative, and that those of ordinary skill in the art may readily devise their own modifications and implementations that incorporate the principles of the present invention and fall within the spirit and scope thereof.

1. A reel comprising:
a core having a first end region;
a first flange;
a first hub member; and
a first bonded joint connecting the first hub member to the first end region of the core, the first bonded joint including a first susceptor material arranged between the first hub member and the first end region of the core,
wherein the first hub member and the first end region of the core are bonded together around the first susceptor material in such a way that the first flange is interposed between the first hub member and the first end region of the core.

2. The reel of claim 1, wherein the first hub member includes a disk portion and a plurality of axially-extending projections, the first bonded joint connecting the axially-extending projections to the first end region of the core.

3. The reel of claim 2, wherein the first flange defines a plurality of elongated apertures, each of which is received in a corresponding one of the plurality of elongated apertures.

4. The reel of claim 3, wherein the first flange defines an annular channel in which the first end region of the core is arranged.

5. The reel of claim 4, wherein each of the plurality of axially-extending projections includes at least one protuberance, the flange being interposed between the at least one protuberance of the plurality of axially-extending and the disk portion of the hub members.

6. The reel of claim 5, wherein each of plurality of axially-extending projections includes an axial groove in which the susceptor material is arranged.

7. The reel of claim 6, wherein the axial groove is arranged at a radially outer side of each of the plurality of axially-extending projections.

8. The reel of claim 7, wherein the axial groove has a radially inner portion having a wedge shape and a radially outer portion having a generally rectangular shape.

9. The reel of claim 5, wherein an axial end portion of each of the axially-extending projections includes an angled lead-in.

10. The reel of claim 5, wherein each of the plurality of elongated apertures partially overlaps the annular channel in a radial direction.

11. The reel of claim 4, wherein the susceptor material is at least partially interposed between an axial end surface of the core and an axial end surface of the plurality of axially-extending projections.

12. The reel of claim 11, wherein the axially-extending projections are arc-shaped.

13. The reel of claim 11, wherein the core includes a hollow cylindrical body and a plurality of ribs projecting radially inwardly from an inner circumferential surface of the hollow cylindrical body.

14. The reel of claim 13, wherein each of the plurality of ribs includes a ledge which engages an inner side surface of the flange.

15. The reel of claim 14, wherein:
the annular channel is defined by an inner circumferential wall and an outer circumferential wall, and
the plurality of elongated apertures are defined by axial extensions of the inner and outer circumferential walls of the annular channel.

16. A method of producing a reel comprising:
arranging a first hub member in a plurality of apertures in a first flange;
arranging each one of a plurality of susceptor members into a corresponding one of the plurality of apertures;
inserting a first end region of a core into an annular channel of the first flange; and
applying a magnetic field to the plurality of susceptor members to produce a bonded joint between at least the first end region of the core and the hub member.

17. The method of claim 16, wherein the arranging of each one of the plurality of susceptor members includes arranging each one of the plurality of susceptor members in contact with the first hub member and the first end region of the flange.

18. The method of claim 17, further comprising:
applying an axial force urging the core and the first hub member toward one another during the application of the magnetic field.

19. The method of claim 16, wherein the arranging of the first hub member in the plurality of apertures includes inserting each one of a plurality of projections into a corresponding one of the plurality of apertures and engaging an inner side surface of the first flange with a protuberance of each of the plurality of projections.

20. The method of claim 16, wherein the arranging of the first hub member in the plurality of apertures includes inserting each one of a plurality of projections into a corresponding one of the plurality of apertures in such a way that the plurality of susceptor members are interposed between the plurality of projections and an end surface of the first end region of the core.
